(19) United States
(12) Patent Application Publication
(10) Pub. No.: US 2013/0332992 A1
(43) Pub. Date: Dec. 12, 2013

(54) METHODS AND SYSTEMS FOR IDENTIFYING A TRUSTABLE WORKFLOW BASED ON A COMPREHENSIVE TRUST MODEL

(71) Applicants: Hyun Joo Kim, Rochester, NY (US); Gueyoung Jung, Rochester, NY (US); Tong Sun, Penfield, NY (US)

(72) Inventors: Hyun Joo Kim, Rochester, NY (US); Gueyoung Jung, Rochester, NY (US); Tong Sun, Penfield, NY (US)

(73) Assignee: XEROX CORPORATION, Norwalk, CT (US)

(21) Appl. No.: 13/494,399

(22) Filed: Jun. 12, 2012

(51) Int. Cl. G06F 21/00

(52) U.S. Cl. 726/2

(57) ABSTRACT

Methods and systems for identifying a trustable workflow based on a comprehensive trust model. One or more trustable links between two or more abstract services among a number of combinations of concrete services can be searched and the trustable link combined to realize an abstract workflow so as to construct a candidate trustable workflow space. The K trustable workflows can be determined by randomly selecting the trustable link with respect to each pair of connected abstract services and combining the selected trustable links. The trustable link in the workflow can be selected to be replaced with another candidate trustable link to provide a higher selection probability to the trustable link in a critical path.

### TECHNICAL FIELD

Embodiments are generally related to the field of business workflow management. Embodiments are also related to trust management techniques. Embodiments are additionally related to the identification of trustable workflow based on a comprehensive trust model.

### BACKGROUND OF THE INVENTION

A business process and/or a workflow can constitute a collection of related, structured activities or tasks that produce a specific service or a product (e.g., serve a particular goal) for a particular customer. Driven by the increasing demand in business for agility and cost efficiency, many businesses are searching for ways to configure distributed services into their business processes. With the advent of cloud computing, many services can be provided by diverse service providers via a cloud service with varying degrees of performance quality and cost factors. During a workflow generation phase, for example, it is critical to maintain a holistic evaluation with respect to not only traditional QoS (Quality of Service) metrics, but also to the trustworthiness of the end-to-end workflow. Conventional workflow generation approaches primarily focus on performance or cost metrics. Such approaches do not consider trustworthiness of the end-to-end workflow.

Based on the foregoing, it is believed that a need exists for an improved system and method for identifying a trustable workflow based on a comprehensive trust model, as will be described in greater detailed herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved business workflow management method and system.

It is another aspect of the disclosed embodiments to provide for an improved method and system for identifying a trustable workflow based on a comprehensive trust model.

It is a further aspect of the disclosed embodiments to provide for an improved method and system for optimizing a workflow utilizing an extended combined trust social network and a heuristic algorithm.

The aforementioned aspects and other objectives and advantages can now be achieved as described herein. A system and method for identifying a trustable workflow based on a comprehensive trust model is disclosed herein. A trustable link between two or more abstract services among a number of combinations of concrete services can be searched and the trustable link combined to realize an abstract workflow so as to construct and configure a candidate concrete workflow. The K number of optimized concrete workflows can be found by searching the space of candidate concrete workflows by randomly selecting the trustable link with respect to each pair of connected abstract services and combining the selected trustable links to build the workflows. An end-to-end trustworthiness and partial sub-flow trustworthiness can be evaluated by calculating reputation, risk, and incentive factor for each generated workflow. The trustable link in the critical path of the workflow can be selected with high selection probability to replace with another candidate trustable link so that more trustable workflows can be found faster. A new set of workflow can be compared with the original set of workflow and a worse workflow from the original set can be replaced with a better workflow from the new set to prevent solutions from quickly converging to a local optimum and to explore various search space.

A trustable service among the concrete services for a beginning abstract service can be searched by walking n hops in the combined trust network for each consecutive pair of abstract services of the workflow. If there is no trustable service for the abstract service, a trustable service among its concrete services can be recommended. A consecutive usage with respect to any of the concrete services for an ending abstract service by similar user can be searched from each trustable service of the beginning abstract service. The trustable links can be collected by walking n hops in the combined trust network. If there is no trustable link between the pair of abstract services, a trustable link (alternative trust link) can be recommended by the concrete service for the ending abstract.

At least one trustable service can be connected with any trustable service of a previous service as well as with any trustable services of a following service in order to connect the trustable links and form the workflow. A virtual link can be added to connect the trustable links and form the workflow if interconnection between previous trustable links and the following trustable links does not exist. A zero reputation can be employed for a recommended service, the alternative trust link, and the virtual link. A risk can be calculated with respect to the zero reputation. An additional trust incentive can be imposed for the consecutive usage for more services after the workflow is generated by combining the trustable links.

The users can impose importance factors on each service and link when certain services or links are significant. The selection probability can be calculated by normalizing the reciprocal of the trustworthiness value of each sub-flow in order to permit the search process to improve the trustworthiness of candidate workflow with higher chance but less memory space. Each service and link can be differentiated so that the user can add additional weight on certain services and/or links to increase the reputation value of the workflow. Such an approach determines the optimal workflow in an agile way with less memory space by adopting critical paths in the search approach and returns more reasonable results.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a trustable workflow identifying module, an operating system, and a user interface, in accordance with the disclosed embodiments;

FIG. 3 illustrates a block diagram of a trustable workflow identifying system, in accordance with the disclosed embodiments;

FIG. 4 illustrates a schematic view of an abstract service, a concrete service, a trustable service, and a trustable link, in accordance with the disclosed embodiments;

FIG. 5 illustrates a high level flow chart of operations illustrating logical operational steps of a method for identifying a trustable workflow based on a comprehensive trust model, in accordance with the disclosed embodiments;

FIG. 6 illustrates a schematic view of an abstract service pair to be investigated through a combined trust network from FIG. 5, in accordance with the disclosed embodiments;

FIG. 7 illustrates a schematic view of a recommended alternative trust link, in accordance with the disclosed embodiments;

FIGS. 8-9 illustrate a schematic view of a disconnection in the workflow and virtual links to address the disconnection, in accordance with the disclosed embodiments;

FIG. 10 illustrates an algorithm to determine the trustable links for each pair of consecutive services in the workflow utilizing the combined trust network, in accordance with the disclosed embodiments; and

FIGS. 11-12 illustrate an algorithm to determine K optimized trustable workflow from the trustable links, in accordance with the disclosed embodiments.

### DETAILED DESCRIPTION

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the block or blocks.

In general, the disclosed embodiments relate to various methods and systems, preferred and alternative, for identifying a trustable workflow based on a comprehensive trust model. One or more trustable links between two or more abstract services among a number of combinations of concrete services can be searched and the trustable link combined to realize an abstract workflow so as to construct a candidate trustable workflow space. The K trustable workflows can be determined by randomly selecting the trustable link with respect to each pair of connected abstract services and combining the selected trustable links. An end-to-end trustworthiness and partial sub-flow trustworthiness can be evaluated by calculating reputation, risk, and incentive factor for each generated workflow. The trustable link in the workflow can be selected to replace with another candidate trustable link to provide a higher selection probability to the trustable link in a critical path. As will be discussed in greater detail herein, K trustable workflows can continue to update to maintain the most trustable workflows among the investigated trustable workflows.

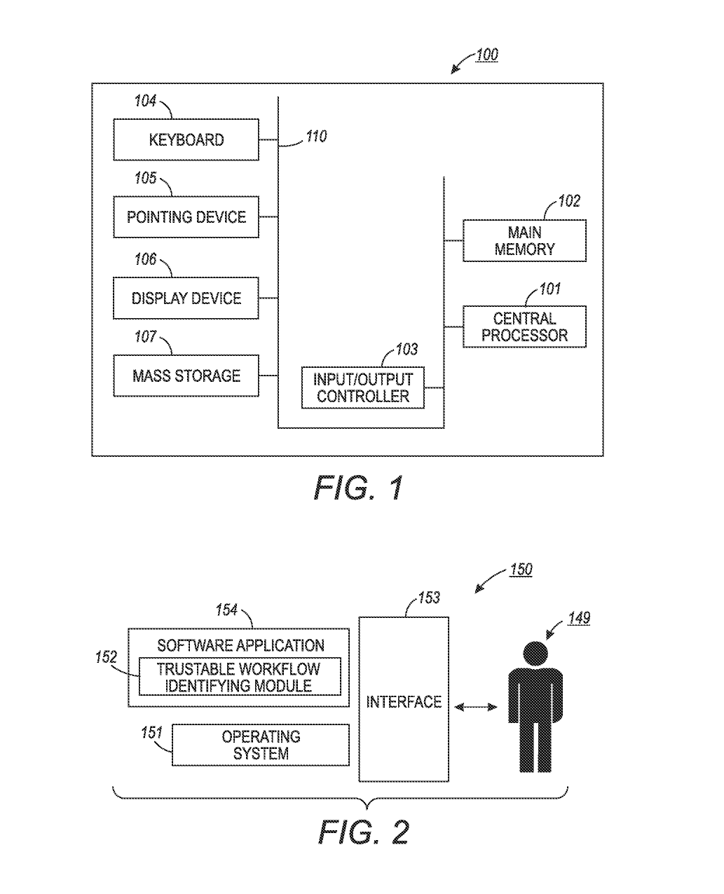

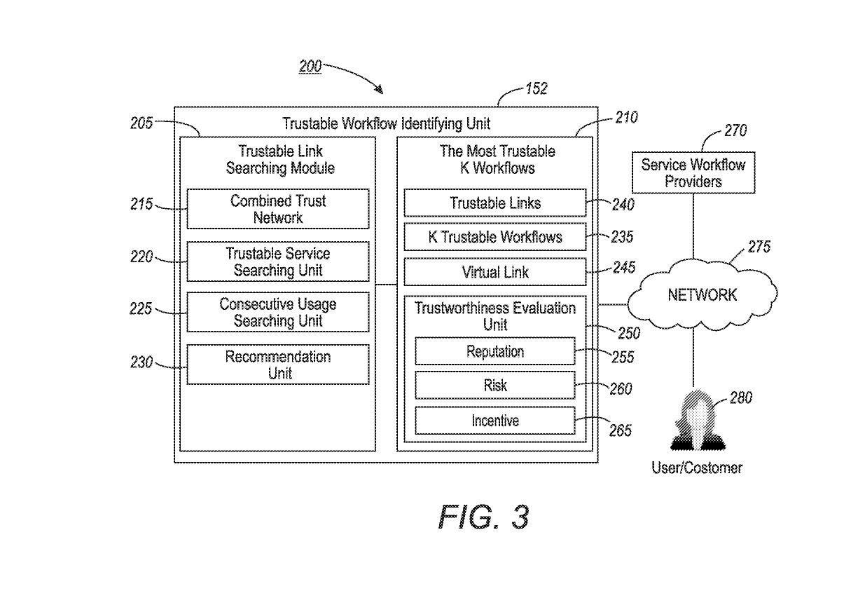

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, and pen device, etc.), a display device 106, and a mass storage 107 (e.g., a hard disk). Other components such as, for example, a USB (Universal Serial Bus) peripheral connection can also connect and/or communicate with the system bus 110. As illustrated, the various components of data-processing system 100 can communicate electronically through the system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

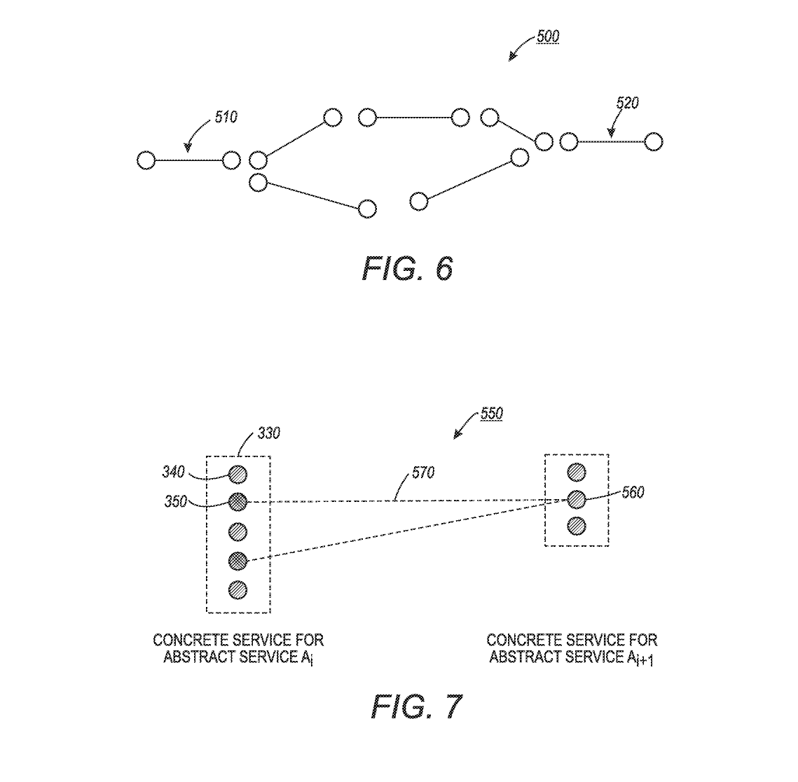

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system other operation systems such as, for example, Linux may also be employed with respect to operating system 151 and interface 153. The software application 154 can include a trustable workflow identifying module 152 for identifying a trustable workflow based on a comprehensive trust model. Software application 154, on the other hand, can include instructions such as the various operations described herein with respect to the various components and modules described herein such as, for example, the method 400 depicted in FIG. 5.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

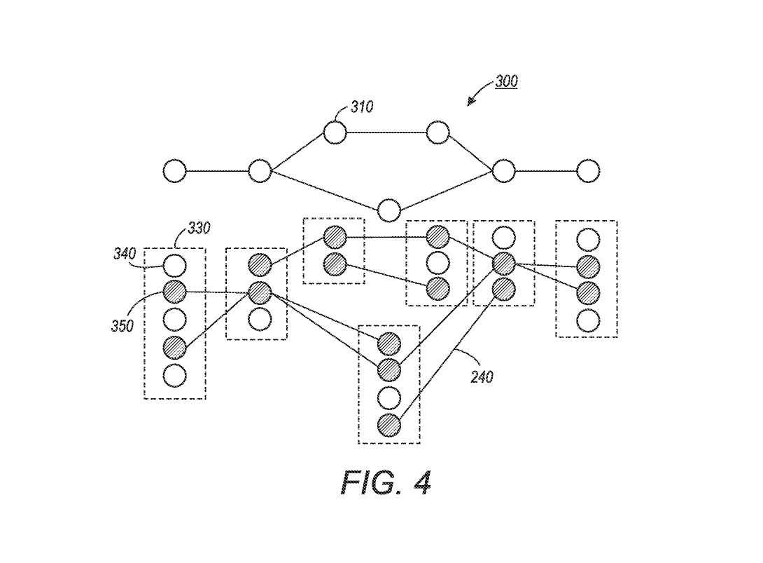

FIG. 3 illustrates a block diagram of a trustable workflow identifying system 200, in accordance with the disclosed embodiments. Note that in FIGS. 1-12, identical parts or elements are generally indicated by identical reference numerals. The trustable workflow identifying system 200 includes a number of components and/or modules such as, for example, a trustable workflow identifying module or unit 152, which communicates with a network 275 that in turn can be connected (e.g., wired, wireless, etc.) to one or more service providers 270 and a user/customer 280. It can be appreciated that the unit or module 152 and sub-modules or sub-units thereof can be composed of software modules.

The trustable workflow identifying module or unit 152 includes, for example, a trustable link searching module 205 that can communicate with a K optimized concrete workflow identifying module or unit 210. The trustable link searching module 205 can include a combined trust network module 215, a trustable service searching module or unit 220, a consecutive usage searching module or unit 225, and a recommendation module or unit 230. The K optimized concrete workflow identifying unit can include a module 240 for generating trustable links, a module 235 for generating a K trustable workflow, and a module 245 for generating a virtual link. The K optimized concrete workflow identifying module or unit 210 can also include a trustworthiness evaluation module or unit 250, which includes a module 255 for generating reputation data, a module 260 for generating risk data, and a module 265 for generating incentive data.

In general, the service workflow provider 270 can provide a number of business management functions and services to one or more of the users 280 via the network 275. Note that the term “user” can refer to, for example, a seller or a provider of particular goods or services. The term “user” can also refer to a buyer or purchaser of goods or services.

The network 275 may employ any network topology, transmission medium, or network protocol. The network 275 may include connections such as wire, wireless communication links, or fiber optic cables. Network 275 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages.

Note that a “service recommendation” is the process to automatically identify the usefulness of (web) service categories or instances in a given situation, and then proactively discover and recommend services to an end-user. The term “trust” as utilized herein can refer to any positive relationship conductive to trust in the real world, for example, friendship, kinship, and business transactions among users and services. Similarly, a user liking a social object (e.g., post, photo, video) or service is also appropriate. Meanwhile, the frequency and time spent on the interactions with other users and services also imply such a “trust”.

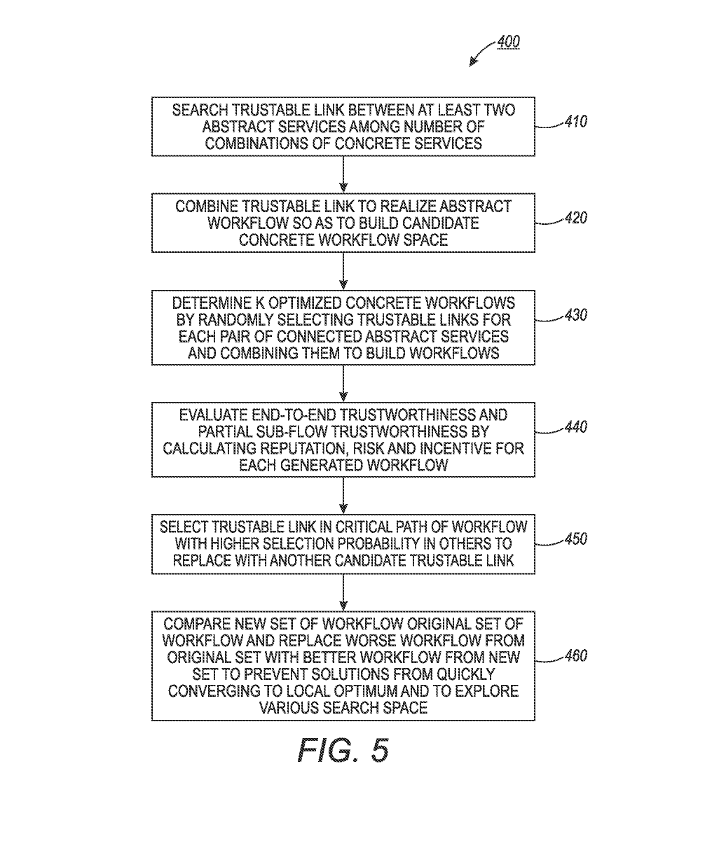

FIG. 4 illustrates a schematic view of an abstract service 310, a concrete service 340, a trustable service 350, a concrete service set for an abstract service 330, and a trustable link 235, in accordance with the disclosed embodiments. In general, a workflow consists of many steps ordered to execute so that a step can start after a previous step is completed. Each step runs a service and the three types of services 310, 340, and 350 are defined as follows. The abstract service 310 represents a high level business task or a conceptual task definition. A workflow can be assumed to be a sequence of abstract services when a user defines the workflow. The workflow with abstract is an abstract workflow.

Many services can be employed to realize the abstract service utilizing different methods or applications. Each specific service can be defined to realize the abstract service 310 as the concrete service 340. For example, image processing can be abstract service and specific algorithm to realize the image processing can be different concrete services. The workflow consisting of the concrete services is a concrete workflow. Since there are multiple alternative concrete services for each abstract service, and the combination of concrete services can be concrete workflows, there can be multiple alternative concrete workflows to realize the abstract workflow.

Among the concrete services 340, if there is any usage experience for the concrete service 340 from the user's social relationship, then it is the trustable service 350. The trustable service 350 is equal or sub-set of concrete services. The trustable link 240 represents a special type of link between services. If there is any consecutive usage experience of the same user from the concrete service 340 to another concrete service 340 in the social relationship, it is the trustable link 240. The concrete services 340 that are connected with the trustable links 240 are also trustable, so they are trustable services.

The trustable workflow identifying unit 152 includes a trustable link searching module 205 and a most trustable K workflows identifying unit 210. Note that one of the goals of unit 210 is to find the K number of the most trustable workflows among trustable workflows. It is evaluated by “trustworthiness” factors such as, for example, reputation, risk, and incentive. The trustable link searching module 205 includes a trustable service searching unit 220 to search the trustable service 350 among the concrete services 340 for a beginning abstract service by walking n hops in a combined trust network 215 for each consecutive pair of abstract services 310 of the workflow. A recommendation unit 230 recommends the trustable service 350 among its concrete services 340 if there is no trustable service 350 for the abstract service 310. A consecutive usage searching unit 225 searches a consecutive usage with respect to any of the concrete services 340 for the ending abstract services by a similar user from each trustable service 350 of the beginning abstract service. The trustable link 240 can be collected by walking n hops in the combined trust network 215. The recommendation unit 230 recommends a trustable link (alternative trust link) by the concrete service for the ending abstract if there is no trustable link between the pair of abstract services.

The most trustable K workflows identifying unit 210 determines K trustable workflows 235 by randomly selecting the trustable links 240 for each pair of connected abstract services 310, combining the selected trustable links to build the workflows. A virtual link 245 can be added to connect the trustable links 240 and form the workflow if interconnection between a previous trustable links and the following trustable links does not exists. A trustworthiness evaluation unit 250 evaluates an end-to-end trustworthiness and partial sub-flows' trustworthiness by calculating three factors, for example, a reputation factor 255, a risk factor 260, and an incentive factor 265 for each generated workflow.

The trustable link 240 in critical paths (i.e., critical sub-flows) of the workflow can be selected to be replaced with another candidate trustable link with higher selection probability than those in other paths. A new set of workflow can be compared to the original set and a worse workflows from the original set can be replaced with better workflows from the new set to prevent the solutions from quickly converging to a local optimum and helps to explore various search space.

FIG. 5 illustrates a high level flow chart of operations illustrating logical operational steps of a method 400 for identifying the trustable workflow based on the comprehensive trust model, in accordance with the disclosed embodiments. Initially, as indicated at block 410, the trustable link 240 between at least two abstract services 310 among combinations of concrete services 340 can be searched based on the combined trust network 215. The trustable link 240 can be combined to realize an abstract workflow so as to build a candidate concrete workflow space, as shown at block 420.

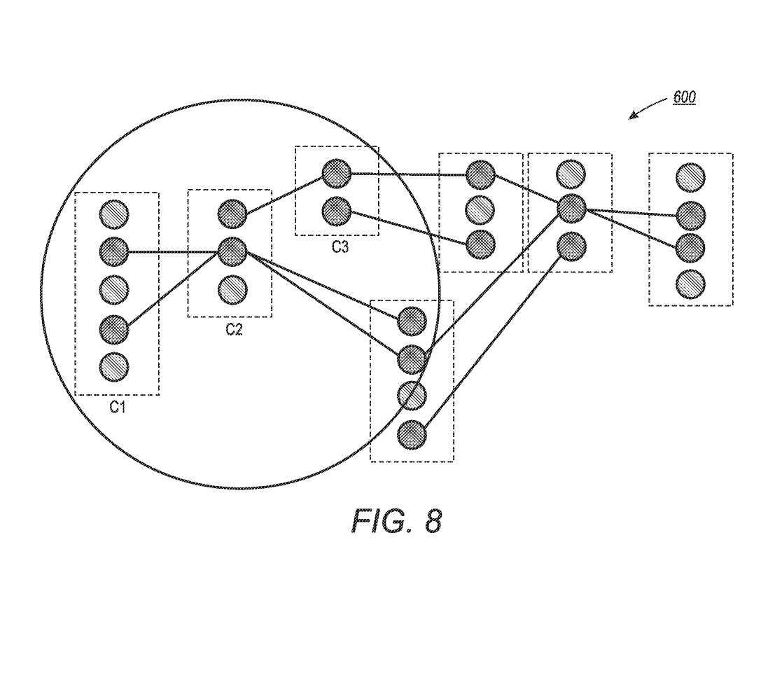

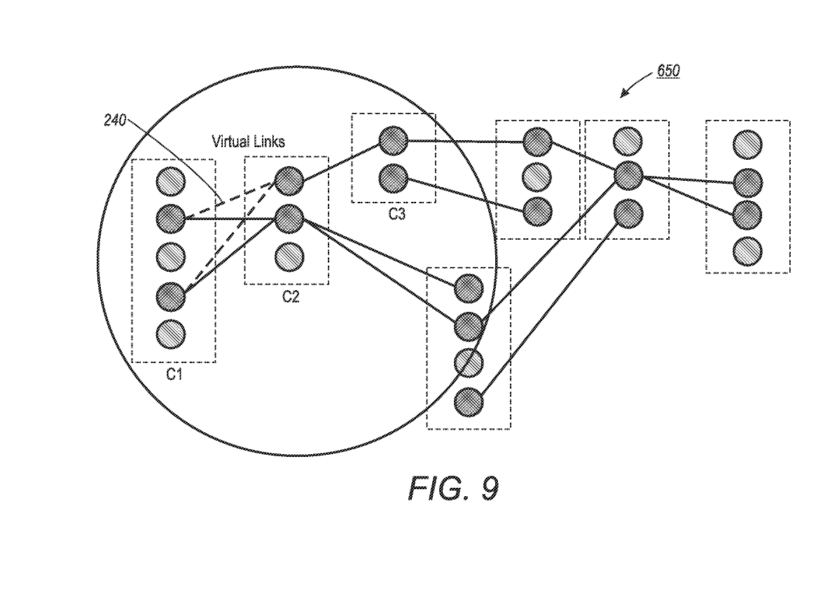

FIG. 6 illustrates a schematic view 500 of an abstract service pair to be investigated through the combined trust network 215 from FIG. 4, in accordance with the disclosed embodiments. A left service 510 of each pair is the beginning service and a right service 520 of the pair is the ending service. From the example of trustable services and links in FIG. 4, the first pair of abstract services possesses two trustable links. The method 400 searches the two trustable services for the beginning abstract service and then determines the trustable link to any concrete services from each trustable service so that two trustable links can be collected. FIG. 7 illustrates a schematic view 550 of a recommended alternative trust link 570, in accordance with the disclosed embodiments. If there is no trustable links found between those two services, the concrete service 560 can be recommended so as to form an alternative trust link 570 as shown in FIG. 7.

Randomly selecting the trustable links 240 for each pair of connected abstract services and combining them, as illustrated at block 430, can determine the K trustable workflows 235. Thereafter, as depicted at block 440, the end-to-end trustworthiness and partial sub-flows' trustworthiness can be evaluated by calculating three factors, which are reputation 255, risk 260, and incentive 265 for each generated workflow. For example, the abstract workflow in FIG. 4 possesses two parallel sub-flows. Hence three flows can be evaluated, one for the overall workflow, and two for two different sub-flows. Then, the workflows with higher trustworthiness can remain in the K set of trustable workflows. This flow is repeated until the overall trustworthiness of the K set of trustable workflows does not improve, and the remaining K set of trustable workflows is determined as the most trustworthy workflows.

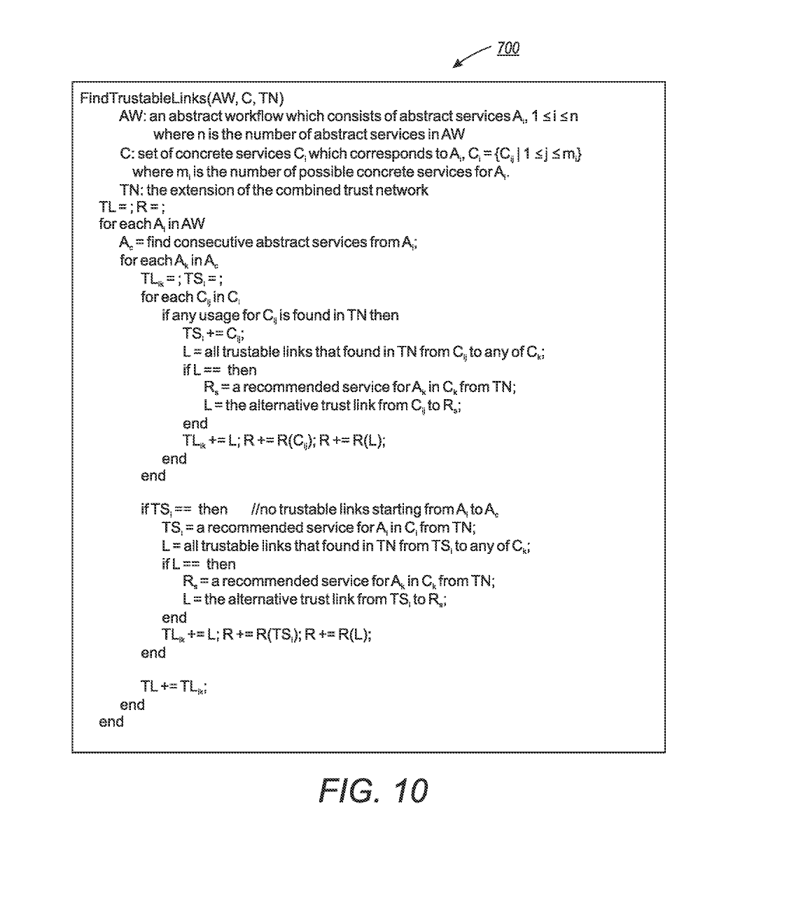

FIGS. 8-9 illustrate a schematic view 600 and 650 of a disconnection in the workflow and virtual links to address the disconnection, in accordance with the disclosed embodiments. The input is the trustable links sets for the pairs of services of the workflow and the output is the K number of most trustable workflows. At least one trustable service can be connected with any trustable service of its previous services as well as with any trustable services of the following service to connect the trustable links and form a workflow. The virtual link 245 can be added to connect trustable links and form a workflow if there may not be any interconnection between previous trustable links and the following trustable links as shown in FIGS. 8-9. The concrete services C2 have a trustable link to C3, but the linked trustable service in C2 has no trustable link from C1 so the workflow is disconnected. The virtual link 245 can be added to trustable services in C1 to form a connected workflow.

The reputation factor represents the sum of the average reputation (or rating) for all trustable services and trustable links. The trustable services and trustable links are assumed to be related after usage. For recommended services, alternative trust links and virtual links, zero can be employed as their reputation.

Tᵣₑₚ=Σᵢ^{TS}R(TSi)+Σᵢ^{TL}R(TLi), (1)

wherein Tᵣₑₚ represents the reputation of a workflow, R(TSi) represents the reputation service I, R(TLi) represents the reputation for trustable link i, TS represents all trustable services, and TL is all trustable links. Even though zero reputation can be employed for recommendation services, alternative trust links, and virtual links, there is still remaining risks. For example, assume a linear workflow with three services and two trustable workflows can be generated. One is the workflow of TS1->TS2->TS3-> where the link TL₁₂ between TS₁ and TS₂ is rated to 2, and the link TL₂₃ between TS₂ and TS₃ is rated to 1. If all the trustable services are rated to the same value 1, for simplicity, then the reputation for the workflows is 6. The other generated workflow is TS₁′->TS₂′->TS₃′ and the rating of TL₁₂′ is 5, but the rating of TL₂₃′ is 0, and then the reputation for the workflow is 8. The latter workflow has a higher reputation, however, this includes the risk by utilizing an unknown trustable link, TL₂₃′, so this can be considered in the evaluation. Hence, the risk can be calculated as shown below in equation (2).

$${T}_{risk} = α ( \frac{N ( TSrisk )}{N ( TS )} + \frac{N ( TLrisk )}{N ( TL )} ) , \qquad ( 2 )$$

wherein Tᵣᵢₛₖ represents the risk of a workflow, N(TSᵣᵢₛₖ) represents the number of known trustable services, N(TS) represents the total number of services, N(TLᵣᵢₛₖ) represents the number of unknown trustable links (alternative trust links and virtual links), and N(TL) represents the total number of links in the workflow.

The trustable link is the consecutive usage from a service to the next service by the same user. However, since the workflow is partitioned into the pairs of services and the trustable links for each pair of consecutive services is determined, usage experience for more than two consecutive services from the same user can be ignored. Hence, after a workflow is generated by combining the trustable links, an additional trust incentive can be imposed for the consecutive usages for more services. For example, if a workflow, TS1->TS2->TS3->TS4->TS5 has a sequence of trustable links, TL₁₂ and TL₂₃ from the same user, which means the user has a usage experience of TS1->TS2->TS3 as a workflow, then this workflow can be evaluated as more trustable than a workflow that consists of trustable links all from different users. The incentive can be calculated as shown below in equation (3).

$${T}_{inc} = β ( \frac{N ( TLcons )}{N ( TL )} ) , \qquad ( 3 )$$

wherein T_{inc} represents the incentive of a workflow, N(TL_{cons}) represents the number of consecutive trustable links from the same user, and N(TL) represents the number of trustable links in the workflow. Hence, the trustworthiness for a workflow can be calculated as follows:

T=Tᵣₑₚ−Tᵣᵢₛₖ+T_{inc} (4)

The trustable link 240 in the workflow can be selected to be replaced with another candidate trustable link to provide higher selection probability to trustable links in critical paths (i.e., critical sub-flows) than those in other paths, as shown at block 450. A new set of workflow can be compared to the original set and a worse workflows from the original set can be replaced with better workflows from the new set to prevent the solutions from quickly converging to a local optimum and helps to explore various search space, as indicated at block 460. The steps can be repeated until the average trustworthiness for K workflows become converged.

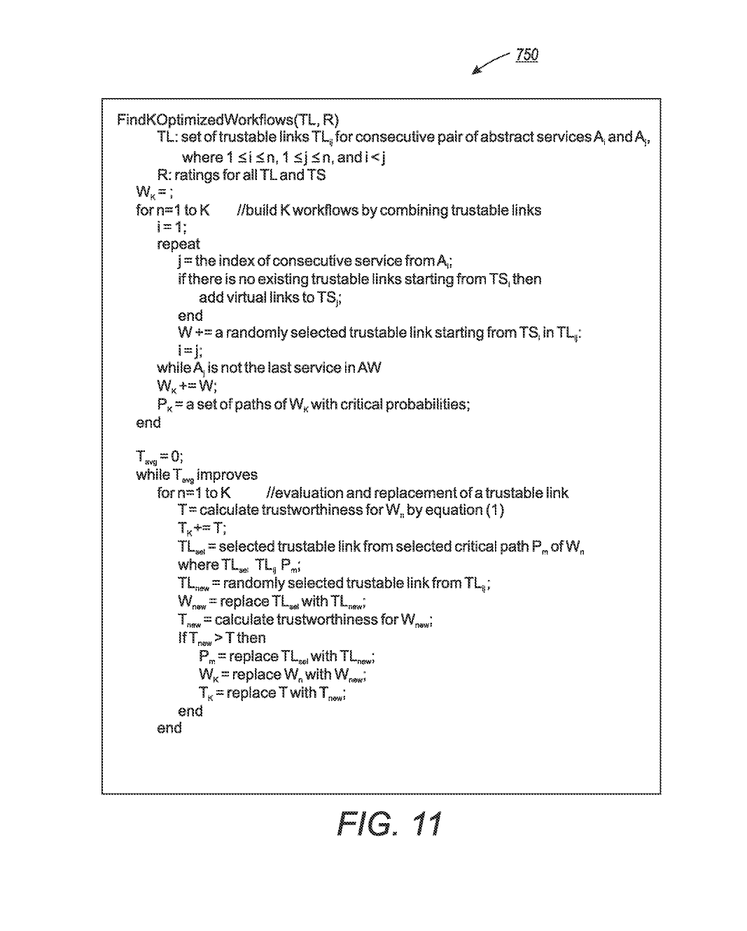

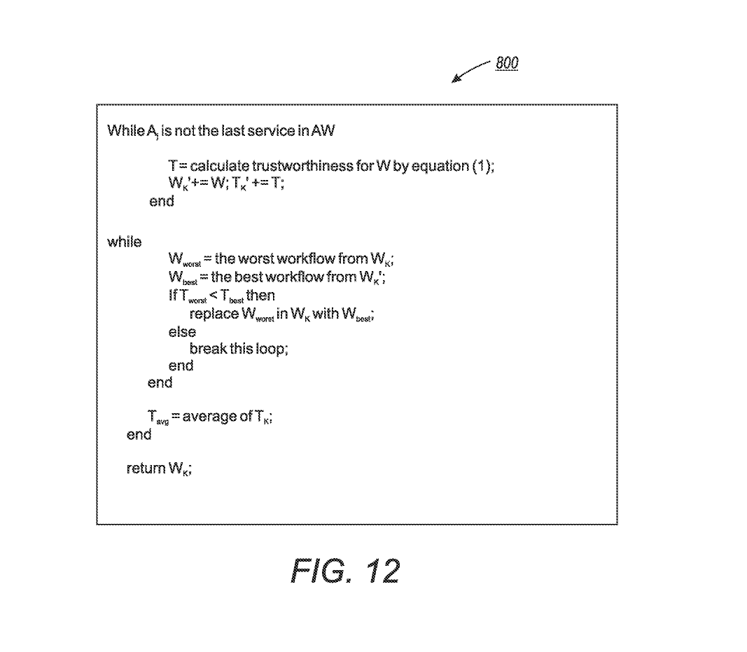

FIG. 10 illustrates an algorithm 700 to determine the trustable links for each pair of consecutive services in a workflow utilizing the combined trust network 215, in accordance with the disclosed embodiments. FIGS. 11-12 illustrate an algorithm 750 to determine K optimized trustable workflow from the trustable links, in accordance with the disclosed embodiments. The users can impose importance factors on each service and link when certain services or links should be considered more importantly than others. The importance factor, i, represents the fraction in and added to the reputation value as a weight. Hence, the equation for reputation changes as follows.

Tᵣₑₚ=Σᵢ^{TS}(R(TSi)+R(TSi)*I(TSi))+Σᵢ^{TL}(R(TLi)+R(TLi)*I(TLi)), (5)

where I(TSᵢ) and I(TLᵢ) are the importance factors for trustable service TSᵢ and trustable link TLᵢ respectively. This aims to put a weight to the workflow which has highly rated services and links for those with high importance factor so that the workflow can have more probability to be selected as a solution. The method 400 provides higher selection probability to the trustable links in critical paths (i.e., critical sub-flows) than those in other paths when the trustable link in the workflow can be selected to be replaced with another candidate trustable link. The critical path indicates the sub-flow that has less trustworthiness than other paths. The selection probability can be calculated by normalizing the reciprocal of trustworthiness value of each sub-flow. Such an approach permits the search process to improve the trustworthiness of candidate workflow with a higher chance but less memory space. Alternatively, all trustworthiness values of all links can be recorded and sorted to choose a link.

The resource allocation (VMs or physical machines) from resource providers (data center/cloud/grid) for a selected trustable workflow can be followed after this work separately considering other performance metrics such as time, cost, network, privacy, etc. The importance factor makes each service and link to be differentiated so that users can add additional weight on certain services and/or links that they consider important. This will increase the reputation value of the workflow which has highly rated services and links for those important services and links, and as a result, the workflow has more chance to be selected as a solution. By adopting critical paths in the search approach, the method 400 can find the optimal workflow in an agile way with less memory space. Since this accelerates the search process to converge into the optimal workflow, the method 400 can return more reasonable results than other approaches even when the search process is stopped due to unexpected system failure or a search time constraint.

Based on the foregoing, it can be appreciated that a number of embodiments, preferred and alternative, are disclosed herien. For example, in one embodiment, a method for identifying a trustable workflow can be implemented. Such a method can include, for example, the steps of searching at least one trustable link between at least two abstract services among a plurality of combinations of concrete services to thereafter combine the at least one trustable link to realize an abstract workflow and construct a candidate trustable workflow space; and determining a most trustable K workflows by randomly selecting the at least one trustable link with respect to each pair of connected abstract services to thereafter evaluate an end-to-end trustworthiness and a partial sub-flow trustworthiness by calculating at least one factor with respect to each generated workflow.

In another embodiment, steps can be provided for selecting the at least one trustable link in a critical path of the workflow with a higher selection probability and replacing with another candidate trustable link; and comparing a new set of workflow to an original set of workflow and replacing a worse workflow from the original set with a better workflow from the new set to prevent solutions from quickly converging to a local optimum and to explore various search space. In yet another embodiment, the step of searching the at least one trustable link can further include the steps of: searching a trustable service among the plurality of concrete services for a beginning abstract service by walking n hops in a combined trust network for each consecutive pair of abstract services of the workflow; and recommending a trustable service among the plurality of concrete services if the trustable service does not exists for the abstract service.

In still another embodiment, the step of searching the at least one trustable link can further include the steps of: searching a consecutive usage with respect to the plurality of concrete services for an ending abstract service by a similar user from each trustable service of the beginning abstract service; collecting the at least one trustable link by walking n hops in the combined trust network; and recommending an alternative trustable link by the concrete service for the ending abstract service if there is no trustable link between the pair of abstract services.

In yet another embodiment, steps can be provided for connecting at least one trustable service with any trustable service of a previous service as well as with any trustable service of a following service in order to connect the at least one trustable link and form the workflow; and adding a virtual link to connect the at least one trustable link and form the workflow if an interconnection between a previous trustable link and a next trustable link does not exist. In some embodiments, the at least one factor can include, for example, a reputation factor, a risk factor, incentive factor, etc.

In other embodiments, steps can be provided for utilizing zero reputation for a recommended service, the alternative trust link and the virtual link and thereafter calculate a risk with respect to the zero reputation; and imposing an additional trust incentive for consecutive usage for more services after the workflow is generated by combining the at least one trustable link. In some embodiments, a step can be provided for imposing an importance factor on each service and link when certain services are significant by the user. In yet other embodiments, a step can be provided for calculating a selection probability by normalizing a reciprocal of the trustworthiness value of each sub-flow in order to permit the search process to improve a trustworthiness of the candidate workflow with less memory space. In still another embodiment, a step can be provided for differentiating the service and link so a user can add an additional weight on certain service to increase a reputation value of the workflow.

In another embodiment, a system for identifying a trustable workflow can be implemented. Such a system can include, for example, a processor; a data bus coupled to the processor; and a computer-usable medium embodying computer program code. The computer-usable medium can be coupled to the data bus. The computer program code can include instructions, for example, which are executable by the processor and configured for: searching at least one trustable link between at least two abstract services among a plurality of combinations of concrete services to thereafter combine the at least one trustable link to realize an abstract workflow and construct a candidate trustable workflow space; and determining a most trustable K workflows by randomly selecting the at least one trustable link with respect to each pair of connected abstract services to thereafter evaluate an end-to-end trustworthiness and a partial sub-flow trustworthiness by calculating at least one factor with respect to each generated workflow.

In another embodiment, such instructions can be further configured for selecting the at least one trustable link in a critical path of the workflow with a higher selection probability and replacing with another candidate trustable link; and comparing a new set of workflow to an original set of workflow and replacing a worse workflow from the original set with a better workflow from the new set to prevent solutions from quickly converging to a local optimum and to explore various search space.

In other embodiments, the instructions for searching the at least one trustable link can be further configured for searching a trustable service among the plurality of concrete services for a beginning abstract service by walking n hops in a combined trust network for each consecutive pair of abstract services of the workflow; and recommending a trustable service among the plurality of concrete services if the trustable service does not exists for the abstract service.

In another embodiment, instructions for searching the at least one trustable link can be further configured for searching a consecutive usage with respect to the plurality of concrete services for an ending abstract service by a similar user from each trustable service of the beginning abstract service; collecting the at least one trustable link by walking n hops in the combined trust network; and recommending an alternative trustable link by the concrete service for the ending abstract service if there is no trustable link between the pair of abstract services.

In other embodiments, the instructions can be further configured for connecting at least one trustable service with any trustable service of a previous service as well as with any trustable service of a following service in order to connect the at least one trustable link and form the workflow; and adding a virtual link to connect the at least one trustable link and form the workflow if an interconnection between a previous trustable link and a next trustable link does not exist. In some system embodiments, the at least one factor can include, for example, a reputation factor, a risk factor, an incentive factor, etc.

In other embodiments, the instructions can be configured for utilizing zero reputation for a recommended service, the alternative trust link and the virtual link and thereafter calculate a risk with respect to the zero reputation; and imposing an additional trust incentive fort consecutive usage for more services after the workflow is generated by combining the at least one trustable link.

In still another embodiment, a processor-readable medium storing code representing instructions to cause a process for identifying a trustable workflow can be implemented. Such a code can include code to search at least one trustable link between at least two abstract services among a plurality of combinations of concrete services to thereafter combine the at least one trustable link to realize an abstract workflow and construct a candidate trustable workflow space; and determine a most trustable K workflows by randomly selecting the at least one trustable link with respect to each pair of connected abstract services to thereafter evaluate an end-to-end trustworthiness and a partial sub-flow trustworthiness by calculating at least one factor with respect to each generated workflow.

In other embodiments, such code can further include code to: select the at least one trustable link in a critical path of the workflow with a higher selection probability and replacing with another candidate trustable link; and compare a new set of workflow to an original set of workflow and replacing a worse workflow from the original set with a better workflow from the new set to prevent solutions from quickly converging to a local optimum and to explore various search space. In yet other embodiments, the code to search the at least one trustable link can further include code to: search a trustable service among the plurality of concrete services for a beginning abstract service by walking n hops in a combined trust network for each consecutive pair of abstract services of the workflow; and automatically recommend a trustable service among the plurality of concrete services if the trustable service does not exists for the abstract service.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for identifying a trustable workflow, said method comprising:
searching at least one trustable link between at least two abstract services among a plurality of combinations of concrete services to thereafter combine said at least one trustable link to realize an abstract workflow and construct a candidate trustable workflow space; and
determining a most trustable K workflows by randomly selecting said at least one trustable link with respect to each pair of connected abstract services to thereafter evaluate an end-to-end trustworthiness and a partial sub-flow trustworthiness by calculating at least one factor with respect to each generated workflow.

2. The method of claim 1 further comprising:
selecting said at least one trustable link in a critical path of said workflow with a higher selection probability and replacing with another candidate trustable link; and
comparing a new set of workflow to an original set of workflow and replacing a worse workflow from said original set with a better workflow from said new set to prevent solutions from quickly converging to a local optimum and to explore various search space.

3. The method of claim 1 wherein searching said at least one trustable link, further comprises:
searching a trustable service among said plurality of concrete services for a beginning abstract service by walking n hops in a combined trust network for each consecutive pair of abstract services of said workflow; and
recommending a trustable service among said plurality of concrete services if said trustable service does not exists for said abstract service.

4. The method of claim 1 wherein searching said at least one trustable link, further comprises:
searching a consecutive usage with respect to said plurality of concrete services for an ending abstract service by similar user from each trustable service of said beginning abstract service;
collecting said at least one trustable link by walking n hops in said combined trust network; and
recommending an alternative trustable link by said concrete service for said ending abstract service if there is no trustable link between said pair of abstract services.

5. The method of claim 1 further comprising:
connecting at least one trustable service with any trustable service of a previous service as well as with any trustable service of a following service in order to connect said at least one trustable link and form said workflow; and
adding a virtual link to connect said at least one trustable link and form said workflow if an interconnection between a previous trustable link and a next trustable link does not exist.

6. The method of claim 1 wherein said at least one factor comprises a reputation factor, a risk factor, and an incentive factor.

7. The method of claim 6 further comprising:
utilizing zero reputation for a recommended service, said alternative trust link and said virtual link and thereafter calculate a risk with respect to said zero reputation; and
imposing an additional trust incentive for consecutive usage for more services after said workflow is generated by combining said at least one trustable link.

8. The method of claim 1 further comprising imposing an importance factor on each service and link when certain services are significant by said user.

9. The method of claim 1 further comprising calculating a selection probability by normalizing a reciprocal of said trustworthiness value of each sub-flow in order to permit said search process to improve a trustworthiness of said candidate workflow with less memory space.

10. The method of claim 1 further comprising differentiating said service and link so a user can add an additional weight on certain service to increase a reputation value of said workflow.

11. A system for identifying a trustable workflow, said system comprising:
a processor;
a data bus coupled to said processor; and
a computer-usable medium embodying computer program code, said computer-usable medium being coupled to said data bus, said computer program code comprising instructions executable by said processor and configured for:
searching at least one trustable link between at least two abstract services among a plurality of combinations of concrete services to thereafter combine said at least one trustable link to realize an abstract workflow and construct a candidate trustable workflow space; and
determining a most trustable K workflows by randomly selecting said at least one trustable link with respect to each pair of connected abstract services to thereafter evaluate an end-to-end trustworthiness and a partial sub-flow trustworthiness by calculating at least one factor with respect to each generated workflow.

12. The system of claim 11 wherein said instructions are further configured for:
selecting said at least one trustable link in a critical path of said workflow with a higher selection probability and replacing with another candidate trustable link; and
comparing a new set of workflow to an original set of workflow and replacing a worse workflow from said original set with a better workflow from said new set to prevent solutions from quickly converging to a local optimum and to explore various search space.

13. The system of claim 11 wherein said instructions for searching said at least one trustable link are further configured for:
searching a trustable service among said plurality of concrete services for a beginning abstract service by walking n hops in a combined trust network for each consecutive pair of abstract services of said workflow; and
recommending a trustable service among said plurality of concrete services if said trustable service does not exists for said abstract service.

14. The system of claim 11 wherein said instructions for searching said at least one trustable link are further configured for:
searching a consecutive usage with respect to said plurality of concrete services for an ending abstract service by a similar user from each trustable service of said beginning abstract service;
collecting said at least one trustable link by walking n hops in said combined trust network; and
recommending an alternative trustable link by said concrete service for said ending abstract service if there is no trustable link between said pair of abstract services.

15. The system of claim 11 wherein said instructions are further configured for:
connecting at least one trustable service with any trustable service of a previous service as well as with any trustable service of a following service in order to connect said at least one trustable link and form said workflow; and
adding a virtual link to connect said at least one trustable link and form said workflow if an interconnection between a previous trustable link and a next trustable link does not exist.

16. The system of claim 11 wherein said at least one factor comprises a reputation factor, a risk factor, and an incentive factor.

17. The system of claim 16 wherein said instructions are further configured for:
utilizing zero reputation for a recommended service, said alternative trust link and said virtual link and thereafter calculate a risk with respect to said zero reputation; and
imposing an additional trust incentive for consecutive usage for more services after said workflow is generated by combining said at least one trustable link.

18. A processor-readable medium storing code representing instructions to cause a process for identifying a trustable workflow, said code comprising code to:
search at least one trustable link between at least two abstract services among a plurality of combinations of concrete services to thereafter combine said at least one trustable link to realize an abstract workflow and construct a candidate trustable workflow space; and
determine a most trustable K workflows by randomly selecting said at least one trustable link with respect to each pair of connected abstract services to thereafter evaluate an end-to-end trustworthiness and a partial sub-flow trustworthiness by calculating at least one factor with respect to each generated workflow.

19. The processor-readable medium of claim 18 wherein said code further comprises code to:
select said at least one trustable link in a critical path of said workflow with a higher selection probability and replacing with another candidate trustable link; and
compare a new set of workflow to an original set of workflow and replacing a worse workflow from said original set with a better workflow from said new set to prevent solutions from quickly converging to a local optimum and to explore various search space.

20. The processor-readable medium wherein said code to search said at least one trustable link, further comprises:
search a trustable service among said plurality of concrete services for a beginning abstract service by walking n hops in a combined trust network for each consecutive pair of abstract services of said workflow; and
automatically recommend a trustable service among said plurality of concrete services if said trustable service does not exists for said abstract service.
